(19) United States
(12) Patent Application Publication
(10) Pub. No.: US 2020/0242231 A1
(43) Pub. Date: Jul. 30, 2020

(54) SYSTEMS TO PROVIDE SECURE CREDENTIALS BETWEEN CLOUD LANDSCAPES

(71) Applicant: SAP SE, Walldorf (DE)

(72) Inventors: Nikolai Neichev, Sofia (BG); Petar Rusev, Sofia (BG)

(21) Appl. No.: 16/260,356

(22) Filed: Jan. 29, 2019

(51) Int. Cl. G06F 21/45; G06F 21/60; H04L 29/06; H04L 9/14; G06F 16/27; H04L 29/14

(52) U.S. Cl. CPC G06F 21/45; G06F 21/602; H04L 63/0428; G06F 2221/2131; G06F 16/27; H04L 69/40; H04L 9/14

(57) ABSTRACT

According to some embodiments, a primary landscape domain database may store secure information (e.g., passwords, secure credentials, etc.) encrypted with a primary landscape key. A secure landscape transfer computer platform, coupled to the primary landscape domain database, may retrieve the secure information and decrypt the secure information at the primary landscape using the primary landscape key. The secure landscape transfer computer platform may also encrypt the secure information using a transport key. A transfer (e.g., by transport or replication) of the secure information encrypted with the transport key may then be arranged by the secure landscape transfer computer platform to a secondary landscape. The transferred secure information may be decrypted at the secondary landscape using the transport key and encrypted at the secondary landscape with a secondary landscape key. The encrypted secure information may then be stored into a domain database at the secondary landscape.

### FIELD

Some embodiments are associated with cloud environment security. In particular, some embodiments provide for an automated transfer of secure information between cloud landscapes.

### BACKGROUND

An enterprise may process information via a cloud landscape. For example, a user, client, tenant, etc. might execute applications (e.g., associated with sales orders, human resources, or enterprise resource management solutions) via a cloud landscape associated with a data center. Some of the information associated with a cloud landscape might be considered “secure information” (e.g., passwords or secure credentials). In some situations, this type of secure information may need to be transported to (or replicated at) another landscape. For example, secure information might need to be accessed by a disaster recovery landscape so that it may be utilized when a primary landscape fails (e.g., due to a natural disaster or cyber-attack). Note that transferring this information between landscapes might expose the secure information and/or encryption passwords to security risks (e.g., the information might be intercepted by an unauthorized party).

It may therefore be desirable to provide systems and methods to facilitate an automated transport or replication of passwords or secure credentials in an accurate and efficient manner.

### SUMMARY OF THE INVENTION

According to some embodiments, systems, methods, apparatus, computer program code and means are provided to facilitate an automated transport or replication of passwords or secure credentials in an accurate and efficient manner. A primary landscape domain database may store secure information (e.g., passwords, secure credentials, etc.) encrypted with a primary landscape key. A secure landscape transfer computer platform, coupled to the primary landscape domain database, may retrieve the secure information and decrypt the secure information at the primary landscape using the primary landscape key. The secure landscape transfer computer platform may also encrypt the secure information using a transport key. A transfer (e.g., by transport or replication) of the secure information encrypted with the transport key may then be arranged by the secure landscape transfer computer platform to a secondary landscape. The transferred secure information may be decrypted at the secondary landscape using the transport key and encrypted at the secondary landscape with a secondary landscape key. The encrypted secure information may then be stored into a domain database at the secondary landscape.

Some embodiments comprise: means for retrieving, by a secure landscape transfer computer platform from a primary landscape domain database, secure information encrypted with a primary landscape key; means for decrypting, by the secure landscape transfer computer platform, the secure information at the primary landscape using the primary landscape key; means for encrypting, by the secure landscape transfer computer platform, the secure information using a transport key; and means for arranging, by the secure landscape transfer computer platform, for the transfer of the secure information encrypted with the transport key to a secondary landscape.

In some embodiments, a communication device associated with a secure landscape transfer engine exchanges information in connection with one or more remote domain databases. The information may be exchanged, for example, via public and/or proprietary communication networks.

Technical effects of some embodiments of the invention are improved and computerized ways to facilitate an automated transport or replication of passwords or secure credentials in an accurate and efficient manner. With these and other advantages and features that will become hereinafter apparent, a more complete understanding of the nature of the invention can be obtained by referring to the following detailed description and to the associated drawings appended hereto.

### BRIEF DESCRIPTION OF THE DRAWINGS

FIG. 1 is a block diagram of a password transport system according to some embodiments.

FIG. 2 illustrates a primary landscape method in accordance with some embodiments.

FIG. 3 illustrates a secondary landscape method in accordance with some embodiments.

FIG. 4 is a block diagram of a security credential replication system according to some embodiments.

FIG. 5 is a method of transporting passwords in accordance with some embodiments.

FIG. 6 is a method of replicating security credentials according to some embodiments.

FIG. 7 is a credentials replication sequence diagram in accordance with some embodiments.

FIG. 8 is a user interface display according to some embodiments.

FIG. 9 is a high-level diagram of an apparatus or platform in accordance with some embodiments.

FIG. 10 is a portion of a transfer database according to some embodiments.

FIG. 11 illustrates a handheld tablet computer in accordance with some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

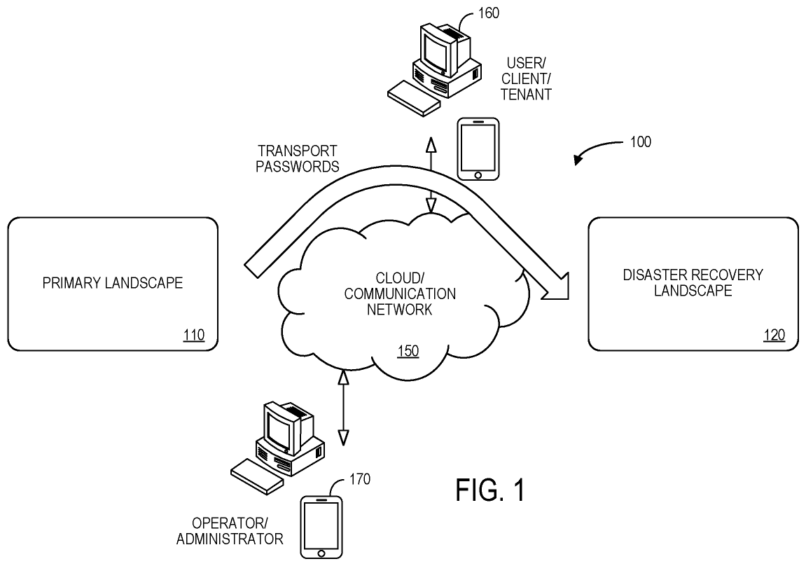

FIG. 1 is a block diagram of a system 100 according to some embodiments. In particular, the system 100 includes a primary landscape 110, a disaster recovery landscape 120, a cloud-based communication network 150, a remote user, client, or tenant computer 160, and a remote operator or administrator computer 170. An enterprise may process information via the primary landscape 110. For example, the user, client, or tenant computer 160 might execute applications (e.g., associated with sales orders, human resources, or enterprise resource management solutions) via the primary landscape 110. Some of the information associated with the primary landscape 110 might include passwords stored in a domain database. In some situations, the passwords might need to be transported to the disaster recovery landscape 120. For example, the passwords might need to be accessed by the disaster recovery landscape 120 so they may be utilized when the primary landscape 110 fails (e.g., due to a natural disaster or cyber-attack). Note that transferring passwords between the landscapes 110, 120 might expose the data and/or encryption passwords to security risks (e.g., the information might be intercepted by an unauthorized party).

According to some embodiments, a secure landscape transfer computer platform (not illustrated in FIG. 1) may access the passwords from the domain database at the primary landscape 110. The secure landscape transfer computer platform may respond to inputs from the operator or administrator computer 170 to initiate a password transfer. The secure landscape transfer computer platform might be, for example, associated with a Personal Computers (“PC”), laptop computer, an enterprise server, a server farm, and/or a database or similar storage devices.

As used herein, devices, including those associated with the secure landscape transfer computer platform and any other device described herein, may exchange information via any communication network which may be one or more of a telephone network, a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

According to some embodiments, an “automated” secure landscape transfer computer platform may support the transfer or secure information between cloud landscapes. As used herein, the term “automated” may refer to, for example, actions that can be performed with little or no human intervention.

The secure landscape transfer computer platform may store information into and/or retrieve information from domain databases (e.g., at the primary landscape 110 and/or disaster recovery landscape 120). The data stores may be locally stored relational database or reside physically remote from the secure landscape transfer computer platform. The term “relational” may refer to, for example, a collection of data items organized as a set of formally described tables from which data can be accessed. Moreover, a Relational Database Management System (“RDBMS”) may be used in connection with any of the database tables described herein. According to some embodiments, a graphical operator interface may provide an ability to access and/or modify elements of the system 100. The operator interface might, for example, let an operator or administrator analyze rule set performance, manage rule set transitions, etc.

Note that any number of secure landscape transfer computer platforms may be included in the system. Moreover, various devices described herein might be combined according to embodiments of the present invention. For example, in some embodiments, the secure landscape transfer computer platform and a domain database might be co-located and/or may comprise a single apparatus. Moreover, the functions described herein might be implemented in a cloud-based environment and/or by a service provider (e.g., performing services for one or more enterprises, departments, or businesses).

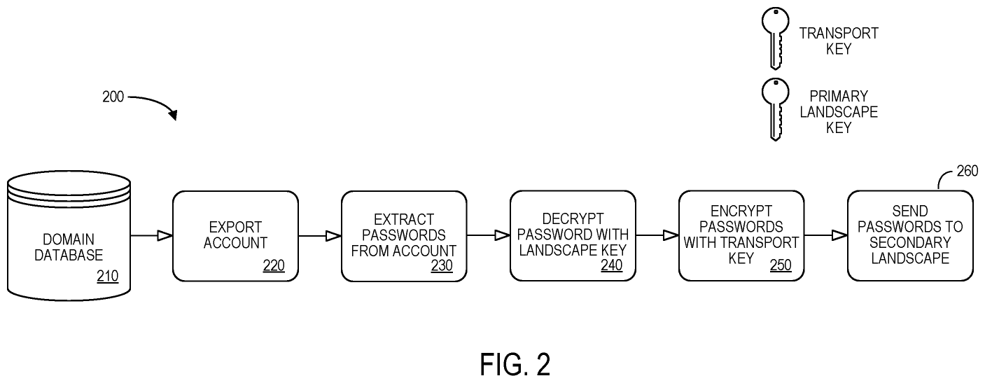

FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

The method 200 of FIG. 2 may provide secure credentials transport between cloud landscapes in accordance with some embodiments. Note that in a cloud platform, the passwords for a customer account may be kept at the landscape on which the account is created. The passwords may be protected with a landscape specific encryption key and stored in a domain database. In some cases, however, in order for the customer accounts to have access to all of the provided functionality on both on the primary landscape and the disaster recovery landscape, it may be necessary for the passwords to be replicated. Currently, there is no secure way to do this (mainly because the passwords are encrypted with a landscape-specific encryption key which is not the same on the disaster recovery landscape). It is necessary first the encrypted passwords to be replicated, and after that to be decrypted on the disaster recover side and encrypted again with the landscape specific key of the disaster recovery landscape.

The password storage provided on each landscape may, according to some embodiments, be accessible from both the primary and secondary sides. In order to access it, the appropriate password is necessary. To solve those problems, embodiments may utilize the following mechanism:

At 220, the system may export account passwords data from a domain database 210 at a primary landscape. That is, the passwords for the given account may be extracted from the domain database 210. This might be done, for example, via a domain database replication agent. The system may extract all of the data for the account to be moved at 230. At this point, the passwords may be encrypted with a primary landscape-specific key. The procedure for preparing the data for transfer to the disaster recovery landscape may consist of the following steps:
at 240, the system may decrypt the passwords with the key specific to the primary landscape;
at 250, the system may encrypt the passwords with a “transport” key, which is available on both landscapes; and
at 260, the system may transfer the data to the disaster recovery landscape.

When the system encrypts passwords with a “transport” key at 250, according to some embodiments the transport key may be one and the same for both the primary and the secondary landscapes. According to some embodiments, the transport key is uploaded to the pair of landscapes one, during the setup in a secure manner by a platform operator. Note that there may be, in some embodiments, a different transport key for each pair of landscapes.

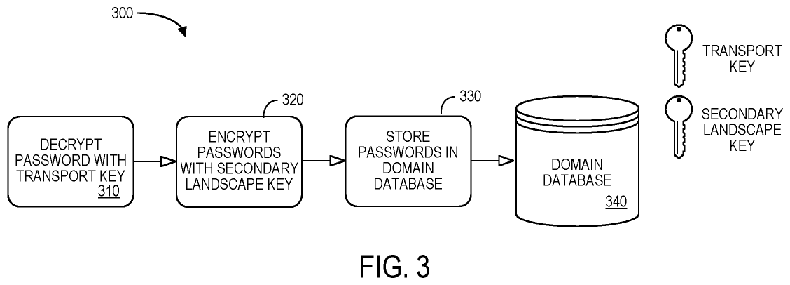

As illustrated in FIG. 3, similar steps may then be performed on the disaster recover side to import the account passwords to the disaster recovery landscape. That is, to import the passwords in the secondary landscape domain database 340, the system may:
at 310, the system may decrypt passwords with the transport key;
at 320, the system may encrypt the passwords with a key that is specific for the disaster recovery landscape; and
at 330, the system may store the data into the domain database 340.

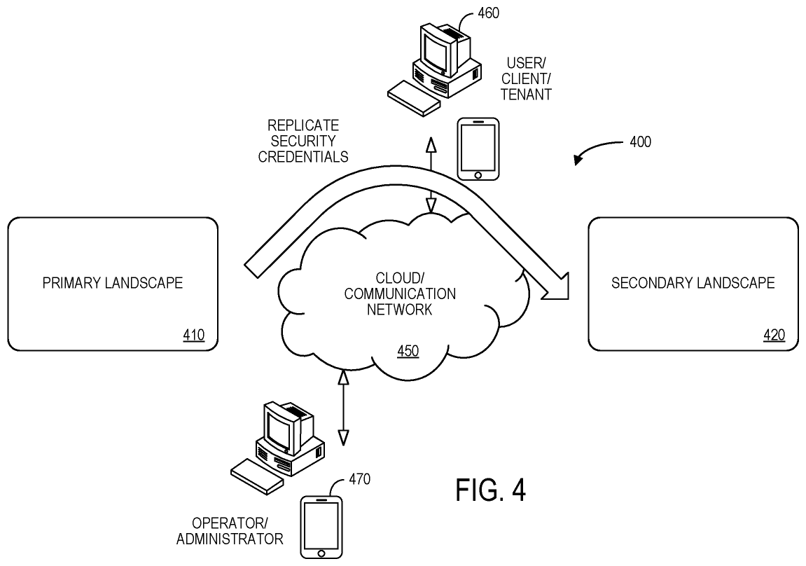

Some embodiments may provide for secure credentials replication in a cloud environment. For example, FIG. 4 is a block diagram of a security credential replication system 400 according to some embodiments. As before, the system 400 includes a primary landscape 410, a secondary landscape 420, a cloud-based communication network 450, a remote user, client, or tenant computer 460, and a remote operator or administrator computer 470.

According to some embodiments, a secure landscape transfer computer platform (not illustrated in FIG. 4) may access the secure credentials from the domain database at the primary landscape 410. The secure landscape transfer computer platform may respond to inputs from the operator or administrator computer 470 to initiate a replication of secure credentials. Currently in a cloud platform, credentials for a customer account may be kept in the landscape at which the account was created. The credentials may be protected with the region-specific encryption key and stored in a domain database. The problem with the replication of the account credentials to a secondary region may include the fact that because the credentials are encrypted with the region-specific encryption key, the system can't replicate them (because on the secondary region the encryption key is different from the primary one and the replicated credentials cannot be manipulated there).

To solve this problem, the system may utilize the following mechanisms. To replicate account secure credentials from the primary landscape 410, the system 400 may initially extract all of the secure credentials for an account from the domain database (e.g., via a domain database replication service). After that, the secure credentials are available but encrypted with a primary landscape-specific key. The procedure to prepare the data for transfer to the secondary region 410 may include:
decrypting the secure credentials with the key specific for the primary landscape 410;
encrypting the passwords with a transport key (available on both landscapes 410, 420); and
transferring the data to the secondary region.

To import the account secure credentials at the secondary landscape 420, the system 400 may initially decrypt passwords with the transport key. The system 400 can then encrypt passwords with the key that is specific for the secondary region and store the data in the domain database at the secondary region.

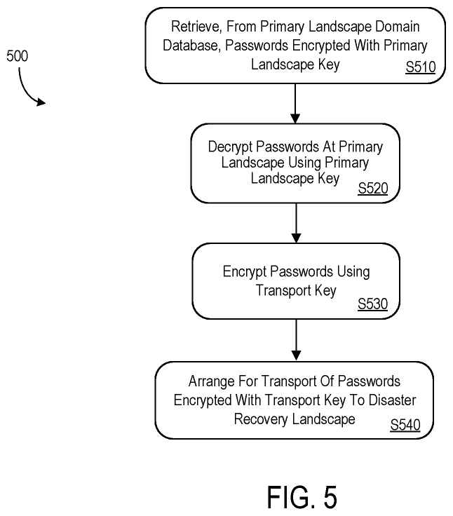

FIG. 5 is a method 500 of transporting passwords in accordance with some embodiments. At S510, the system may retrieve, by a secure landscape transfer computer platform from a primary landscape domain database, secure information encrypted with a primary landscape key. For example, the system may retrieve encrypted passwords. At S520, the system may decrypt, by the secure landscape transfer computer platform, the passwords at the primary landscape using the primary landscape key. At S530, the system may encrypt, by the secure landscape transfer computer platform, the passwords using a transport key. At S540, the system may arrange, by the secure landscape transfer computer platform, for the transport of the passwords encrypted with the transport key to a disaster recovery landscape.

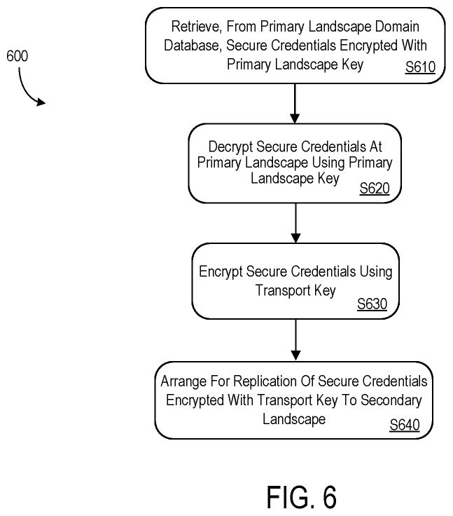

FIG. 6 is a method 600 of replicating security credentials according to some embodiments. At S610, the system may retrieve, by a secure landscape transfer computer platform from a primary landscape domain database, secure credentials encrypted with a primary landscape key. At S620, the system may decrypt, by the secure landscape transfer computer platform, the secure credentials at the primary landscape using the primary landscape key. At S630, the system may encrypt, by the secure landscape transfer computer platform, the secure credentials using a transport key. At S640, the system may arrange, by the secure landscape transfer computer platform, for the replication of the secure credentials encrypted with the transport key to a disaster recovery landscape.

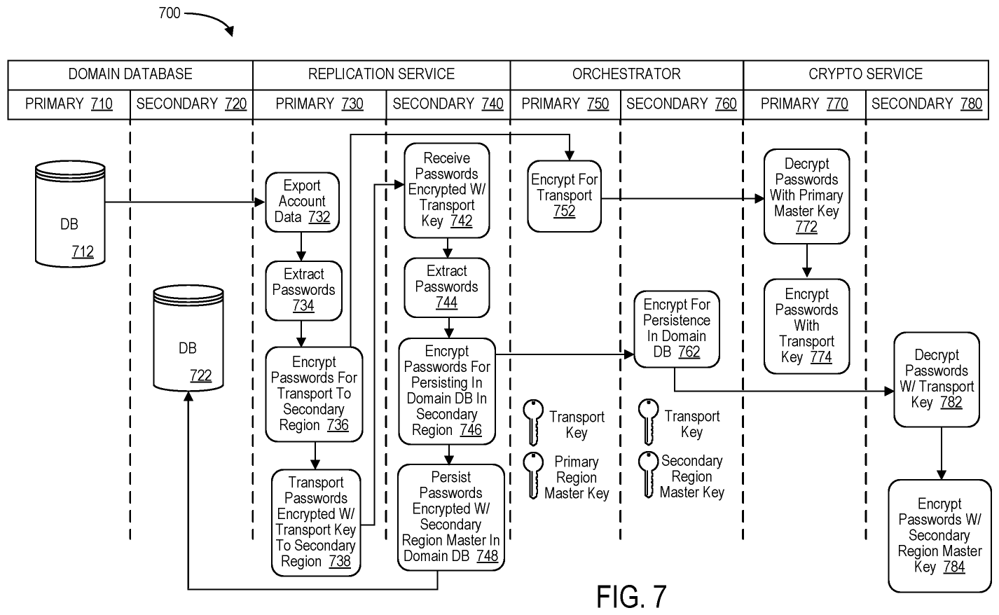

FIG. 7 is a credentials replication sequence diagram 700 in accordance with some embodiments. Note that the overall goal of the diagram 700 may be to securely move secure information from a primary domain database 712 associated with a primary landscape 710 into a secondary domain database 722 associated with a secondary landscape 720. Initially, the information in the primary domain database 712 associated with an account is exported at 732 via a primary replication service 730. The passwords are extracted at 734 and encrypted for transport to a secondary region (using a transport key) at 736. This might include encryption for transport at 752 (by a primary orchestrator 750), decryption with a primary master key at 772 (by a primary crypto service 770), and encryption with the transport key at 774. The passwords encrypted with the transport key may then be transported to the secondary region at 738.

When the passwords encrypted with the transport key are received by a secondary replication service 740 at 742, the passwords may be extracted at 744 and encrypted for persisting in the domain database in the secondary region at 746. This might include encryption for persistence at 762 (by a secondary orchestrator 760), decryption with the transport key at 782 (by a secondary crypto service 780), and encryption with the secondary region key at 784. The passwords encrypted with the secondary region key may then be persisted in the secondary domain database 722 at 748.

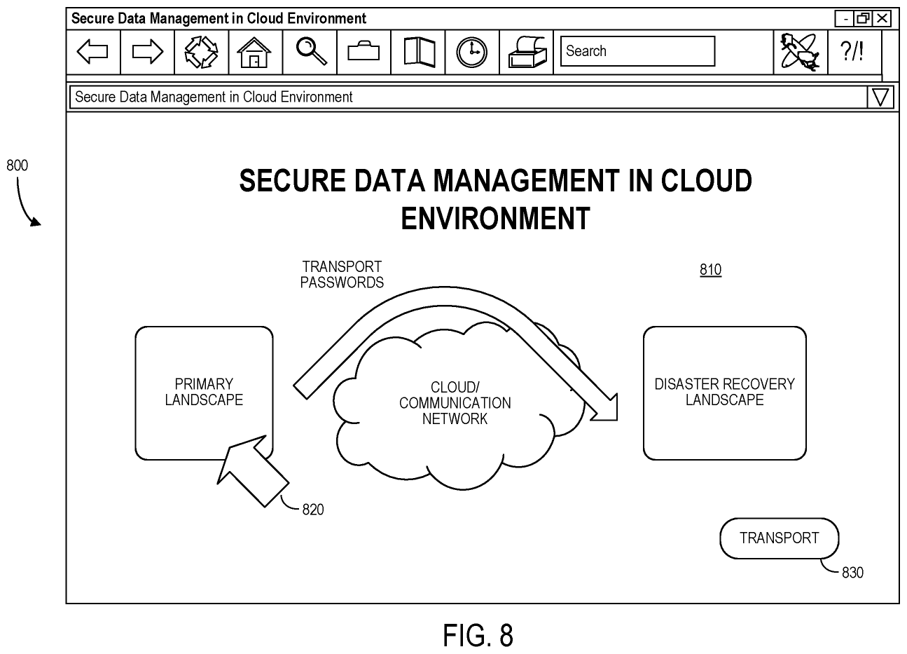

Note that an operator may arrange to monitor or adjust the operation of various replication services, orchestrators, crypto services, etc. For example, FIG. 8 is a user interface display 800 according to some embodiments. The display 800 may provide a graphical depiction 810 of a system (e.g., including a primary and secondary landscape, cloud environment, etc.) to an operator and/or to provide an interactive interface allowing an operator to adjust system components as appropriate. Selection of an element on the display 800 (e.g., via a touchscreen or computer mouse pointer 820) may let the operator see more information about that particular element (e.g., in a pop-up window) and/or adjust operation of that element (e.g., by selecting a new region or transport encryption key). According to some embodiments, selection of a “Transport” icon 830 by an operator may initiate the transfer or replication of secure information between landscapes.

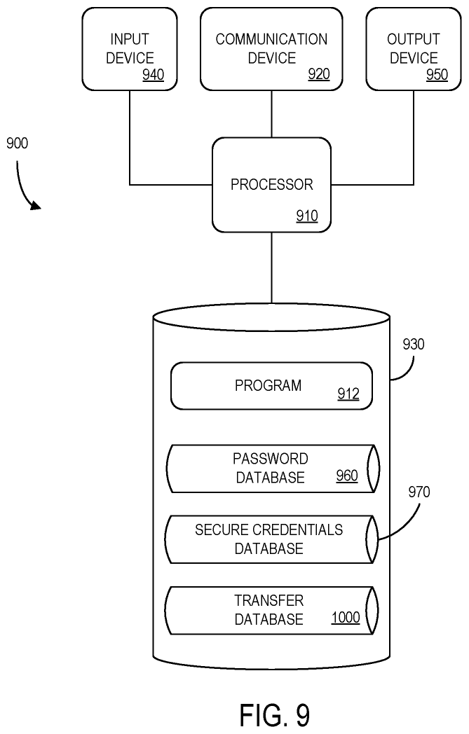

The embodiments described herein may be implemented using any of a number of different computer hardware implementations. FIG. 9 is a block diagram of apparatus 900 according to some embodiments (e.g., the systems 100, 400 of FIGS. 1 and 4, respectively). The apparatus 900 may comprise a general-purpose computing apparatus and may execute program code to perform any of the functions described herein. The apparatus 900 may include other unshown elements according to some embodiments. According to some embodiments, the apparatus 900 includes a processor 910 operatively coupled to a communication device 920, a data storage device 930, one or more input devices 940, and/or one or more output devices 950. The communication device 920 may facilitate communication with external devices, such as remote user or administrator devices. The input device(s) 940 may comprise, for example, a keyboard, a keypad, a mouse or other pointing device, a microphone, knob or a switch, an Infra-Red (“IR”) port, a docking station, and/or a touch screen. The input device(s) 940 may be used, for example, to enter information into the apparatus 900 (e.g., about encryption keys, transport keys, accounts to be moved or replicated, etc.). The output device(s) 950 may comprise, for example, a display (e.g., a display screen) a speaker, and/or a printer (e.g., to provide configuration settings to an operator, summary analytic reports, troubleshooting information, etc.).

The data storage device 930 may comprise any appropriate persistent storage device, including combinations of magnetic storage devices (e.g., magnetic tape, hard disk drives and flash memory), optical storage devices, Read Only Memory (“ROM”) devices, etc., while the memory 960 may comprise Random Access Memory (“RAM”).

The program code 912 may be executed by the processor 910 to cause the apparatus 900 to perform any one or more of the processes described herein. Embodiments are not limited to execution of these processes by a single apparatus. The data storage device 930 may also store data and other program code for providing additional functionality and/or which are necessary for operation thereof, such as device drivers, Operating System (“OS”) files, etc. For example, the processor 910 may retrieve the secure information and decrypt the secure information at the primary landscape using the primary landscape key. The processor 910 may also encrypt the secure information using a transport key. A transfer (e.g., by transport or replication) of the secure information encrypted with the transport key may then be arranged by the processor 910 to a secondary landscape. The transferred secure information may be decrypted at the secondary landscape using the transport key and encrypted at the secondary landscape with a secondary landscape key. The encrypted secure information may then be stored into a domain database at the secondary landscape.

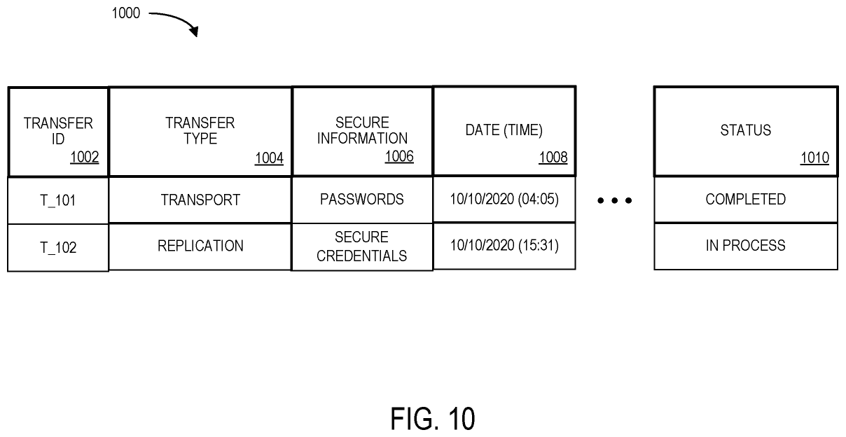

In some embodiments (such as shown in FIG. 9), the storage device 930 further stores a password database 960 (e.g., containing encrypted user names and passwords), a secure credentials database 970 (to store encrypted biometric data, meta-data, etc.), and a transfer database 1000. An example of a database that may be used in connection with the apparatus 900 will now be described in detail with respect to FIG. 10. Note that the database described herein is only one example, and additional and/or different information may be stored therein. Moreover, various databases might be split or combined in accordance with any of the embodiments described herein.

Referring to FIG. 10, a table is shown that represents the transfer database 1000 that may be stored at the apparatus 900 according to some embodiments. The table may include, for example, entries identifying accounts that have been migrated between landscapes. The table may also define fields 1002, 1004, 1006, 1008, 1010 for each of the entries. The fields 1002, 1004, 1006, 1008, 1010 may, according to some embodiments, specify: a transfer identifier 1002, transfer type 1004, secure information 1006, a date and time 1008, and a status 1010. The transfer database 1000 may be created and updated, for example, based on information received via an operator, as accounts are migrated or replicated, etc.

The transfer identifier 1002 may be, for example, a unique alphanumeric code identifying an account migration or replication that was (or will be) executed. The transfer type 1004 might define a category of migration (e.g., transport or replication). The secure information 1006 might define a category of information being securely moved (e.g., passwords or secure credentials). The date and time 1008 might indicate when the information was (or will be) securely moved between landscapes. The status 1010 might indicate if a migration was completed, is currently in processed, halted, failed, etc.

Thus, embodiments may provide several advantages, such as by providing systems and methods to facilitate an automated transport or replication of passwords or secure credentials in an accurate and efficient manner. This may improve the overall efficiency of an enterprise (by reducing the time, expense, errors, and security risks associated with manual migration and/or transmitting unsecured information or passwords over networks).

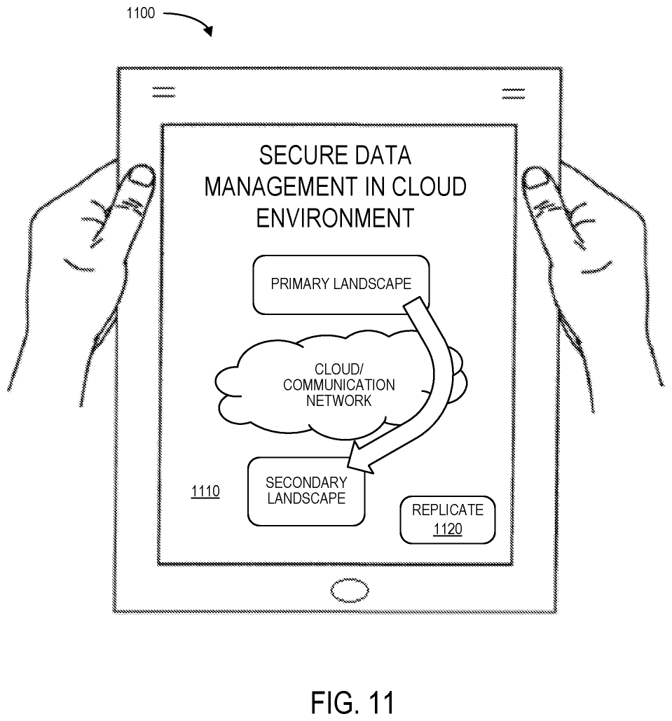

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may comprise any number of hardware and/or software elements suitable to provide the functions described herein as well as any other functions. For example, any computing device used in an implementation of the discussed architectures may include a processor to execute program code such that the computing device operates as described herein. Moreover, the displays described are provided only as examples and other types of displays might be implemented. For example, FIG. 11 shows a handheld tablet computer 1100 in accordance with some embodiments. A display 1110 might provide information about secure data management in a cloud environment and one or more icons 1120 may be selected by the user to adjust operation of the system (e.g., by initiating a transport or migration, selecting accounts, etc.).

All systems and processes discussed herein may be embodied in program code stored on one or more non-transitory tangible computer-readable media. Such media may include, for example, a floppy disk, a CD-ROM, a DVD-ROM, a Flash drive, magnetic tape, and solid-state RAM or ROM storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system associated with cloud environment security, comprising:
(a) a primary landscape domain database storing secure information encrypted with a primary landscape key; and
(b) a secure landscape transfer computer platform, coupled to the primary landscape domain database, adapted to:
(i) retrieve the secure information,
(ii) decrypt the secure information at the primary landscape using the primary landscape key,
(iii) encrypt the secure information using a transport key, and
(iv) arrange for the transfer of the secure information encrypted with the transport key to a secondary landscape.

2. The system of claim 1, wherein the transferred secure information is decrypted at the secondary landscape using the transport key, encrypted at the secondary landscape with a secondary landscape key, and the encrypted secure information is stored into a domain database at the secondary landscape.

3. The system of claim 1, wherein the secure information comprises passwords, the secondary landscape comprises a disaster recovery landscape, and said arranging to transfer is associated with transporting the passwords to a domain database in the disaster recovery landscape.

4. The system of claim 1, wherein the secure information comprises secure credentials and said arranging to transfer is associated with replicating the secure credentials to a domain database in the secondary landscape.

5. The system of claim 4, wherein the secure information is associated with at least one of: (i) a user name, (ii) a client identifier, (iii) tenant information, (iv) biometric information, and (v) meta-data.

6. The system of claim 1, wherein the secure landscape transfer computer platform includes at least one of: (i) a replication service, (ii) an orchestrator, and (iii) a crypto service.

7. The system of claim 1, wherein the cloud environment security is associated with at least one of: (i) a disaster recovery service, (ii) a replication service, and (iii) a global traffic management service.

8. A computer-implemented method associated with cloud environment security, comprising:
retrieving, by a secure landscape transfer computer platform from a primary landscape domain database, secure information encrypted with a primary landscape key;
decrypting, by the secure landscape transfer computer platform, the secure information at the primary landscape using the primary landscape key;
encrypting, by the secure landscape transfer computer platform, the secure information using a transport key; and
arranging, by the secure landscape transfer computer platform, for the transfer of the secure information encrypted with the transport key to a secondary landscape.

9. The method of claim 8, wherein the transferred secure information is decrypted at the secondary landscape using the transport key, encrypted at the secondary landscape with a secondary landscape key, and the encrypted secure information is stored into a domain database at the secondary landscape.

10. The method of claim 8, wherein the secure information comprises passwords, the secondary landscape comprises a disaster recovery landscape, and said arranging to transfer is associated with transporting the passwords to a domain database in the disaster recovery landscape.

11. The method of claim 8, wherein the secure information comprises secure credentials and said arranging to transfer is associated with replicating the secure credentials to a domain database in the secondary landscape.

12. The method of claim 11, wherein the secure information is associated with at least one of: (i) a user name, (ii) a client identifier, (iii) tenant information, (iv) biometric information, and (v) meta-data.

13. The method of claim 8, wherein the secure landscape transfer computer platform includes at least one of: (i) a replication service, (ii) an orchestrator, and (iii) a crypto service.

14. The method of claim 8, wherein the cloud environment security is associated with at least one of: (i) a disaster recovery service, (ii) a replication service, and (iii) a global traffic management service.

15. A non-transitory, computer-readable medium storing program code, the program code executable by a computer processor to cause the processor to perform a method associated with cloud environment security, the method comprising:
retrieving, by a secure landscape transfer computer platform from a primary landscape domain database, secure information encrypted with a primary landscape key;
decrypting, by the secure landscape transfer computer platform, the secure information at the primary landscape using the primary landscape key;
encrypting, by the secure landscape transfer computer platform, the secure information using a transport key; and
arranging, by the secure landscape transfer computer platform, for the transfer of the secure information encrypted with the transport key to a secondary landscape.

16. The medium of claim 15, wherein the transferred secure information is decrypted at the secondary landscape using the transport key, encrypted at the secondary landscape with a secondary landscape key, and the encrypted secure information is stored into a domain database at the secondary landscape.

17. The medium of claim 15, wherein the secure information comprises passwords, the secondary landscape comprises a disaster recovery landscape, and said arranging to transfer is associated with transporting the passwords to a domain database in the disaster recovery landscape.

18. The medium of claim 15, wherein the secure information comprises secure credentials and said arranging to transfer is associated with replicating the secure credentials to a domain database in the secondary landscape.

19. The medium of claim 18, wherein the secure information is associated with at least one of: (i) a user name, (ii) a client identifier, (iii) tenant information, (iv) biometric information, and (v) meta-data.

20. The medium of claim 15, wherein the secure landscape transfer computer platform includes at least one of: (i) a replication service, (ii) an orchestrator, and (iii) a crypto service.
